(19) United States
(12) Patent Application Publication
(10) Pub. No.: US 2024/0296260 A1
(43) Pub. Date: Sep. 5, 2024

(54) SIMULATION METHOD FOR DYNAMIC CONTACT CHARACTERISTICS OF HIGH-SPEED HEAVY-LOAD BALL BEARING IN LIQUID ROCKET ENGINE

(71) Applicant: XI'AN AEROSPACE PROPULSION INSTITUTE, Xi'an City, Shaanxi (CN)

(72) Inventors: Feiping DU, Xi'an City (CN); Yonghua TAN, Xi'an City (CN); Chunmin WANG, Xi'an City (CN); Hui CHEN, Xi'an City (CN)

(73) Assignee: XI'AN AEROSPACE PROPULSION INSTITUTE, Xi'an City, Shaanxi (CN)

(21) Appl. No.: 18/023,049

(22) PCT Filed: Mar. 16, 2022
(86) PCT No.: PCT/CN2022/081259

§ 371 Date: Feb. 24, 2023

(30) Foreign Application Priority Data
Sep. 7, 2021 (CN) 202111041792.3

(51) Int. Cl. G06F 30/20; G06F 17/11; G06F 119/14

(52) U.S. Cl. CPC G06F 30/20; G06F 17/11; G06F 2119/14

(57) ABSTRACT

A simulation method for dynamic contact characteristics of a high-speed heavy-load ball bearing in a liquid rocket engine, mainly including: establishing a low-speed heavy-load ball bearing model of a liquid rocket engine according to a normal contact stress of a ball bearing, and performing iterative computation on the low-speed heavy-load ball bearing model of the liquid rocket engine to obtain static contact characteristics of the heavy-load ball bearing; establishing a high-speed heavy-load ball bearing model of the liquid rocket engine based on a theory of quasi-static analysis; and taking computed values for the static contact characteristics of the heavy-load ball bearing as initial values, substituting the initial values into the high-speed heavy-load ball bearing model, and performing iterative operation through a dual-population co-evolutionary particle swarm optimization (CPSO) algorithm to obtain dynamic contact characteristics of each of balls in the ball bearing.

### CROSS REFERENCE TO RELATED APPLICATION

The present application claims the priority to Chinese Patent Application No. 202111041792.3 with the China National Intellectual Property Administration (CNIPA) on Sep. 7, 2021, and entitled “SIMULATION METHOD FOR DYNAMIC CONTACT CHARACTERISTICS OF HIGH-SPEED HEAVY-LOAD BALL BEARING IN LIQUID ROCKET ENGINE”, which is incorporated herein by reference in its entirety.

### TECHNICAL FIELD

The present disclosure belongs to the field of dynamic characteristics of ball bearings in liquid rocket engines, and mainly relates to a simulation method for dynamic contact characteristics of a high-speed heavy-load ball bearing in a liquid rocket engine.

### BACKGROUND

As an important supporting and rotating component for transferring motions and carrying loads, the bearing has been widely applied to aerospace propulsion systems, ship engineering, precise instruments and other major equipment. In a turbopump rotor system of the liquid rocket engine, the ball bearing is mainly used because of the characteristics of high manufacturing precision, high limit speed, strong load capacity, capability of bearing a radial load and an axial load, etc.

A ball bearing consists of a ball, an inner ring, an outer ring, a cage and the like, and its dynamic characteristics include dynamic contact angles of the ball with the inner ring and the outer ring, contact load, contact deformation, contact rigidity, spin-to-roll ratio, etc. Of particular concern are the dynamic contact angles of the ball with the inner ring and the outer ring.

Conventionally, the ball bearing is designed as a standard component, which can be desirable for general motions. However, for modern high-speed, high-precision and high-load major equipment systems, the ball bearing is greatly different from the common bearing due to the complicated working condition and demanding service performance. Its dynamic characteristics, such as the contact rigidity changing with a rotational speed, are key indicators which affect working performance and product quality of the equipment systems.

With advances in aerospace liquid propulsion technology, the liquid rocket engine has been developed toward the high thrust, high rotational speed, high-low temperature environment, high reliability, etc. As a key component in the turbopump rotor system of the liquid rocket engine, the ball bearing has a very demanding working environment. Generally, the ball bearing having a DN value (inner diameter (mm) rotational speed (r/min)) beyond 0.6×10⁶ mm-r/min is considered as a high-speed ball bearing. In the liquid rocket engine, the ball bearing can be viewed as a high-speed heavy-load ball bearing, because the DN value is up to 2.5×10⁶ mm·r/min, and the ratio of a dynamic equivalent radial load Pr to a dynamic load rating Cr is greater than 0.15. In the high-speed heavy-load ball bearing, bearing failure arising from slip, fatigue, abrasion of the ball occurs frequently, which directly reduces the precision of the rotor system, aggravates the vibration or even makes metal falling from the surface of the ball bearing to enter a turbopump cavity of the liquid rocket engine. While the turbopump is located in a high-pressure (greater than 10 MPa) and low-temperature liquid oxygen environment, the engine is very likely to cause fiery explosion. Moreover, there are a number of nonlinear equation sets for a dynamic model of the ball bearing that are sensitive to an iterative initial value but not prone to convergence in the solving process. Therefore, a method for obtaining dynamic parameters of the high-speed heavy-load ball bearing is needed urgently.

### SUMMARY

In view of this, an objective of the present disclosure is to provide a simulation method for dynamic contact characteristics of a high-speed heavy-load ball bearing in a liquid rocket engine. The method can obtain dynamic contact characteristic parameters and changing rules of the ball bearing in the liquid rocket engine from a static state to a dynamic state, a single load to a combined load, and a low rotational speed to a high rotational speed.

The basic ideas of the present disclosure are as follows:

The present disclosure provides a simulation method for dynamic contact characteristics of a high-speed heavy-load ball bearing in a liquid rocket engine, including the following steps:
establishing a low-speed heavy-load ball bearing model of a liquid rocket engine according to a normal contact stress of a ball bearing, and performing iterative computation on the low-speed heavy-load ball bearing model of the liquid rocket engine to obtain static contact characteristics of the low-speed heavy-load ball bearing;
establishing a high-speed heavy-load ball bearing model of the liquid rocket engine based on a theory of quasi-static analysis; and
taking computed values for the static contact characteristics of the low-speed heavy-load ball bearing as initial values, substituting the initial values into the high-speed heavy-load ball bearing model, and performing iterative operation through a dual-population co-evolutionary particle swarm optimization (CPSO) algorithm to obtain dynamic contact characteristics of each of balls in the ball bearing, where the dynamic contact characteristics include a contact angle between the ball and an inner ring, and a contact angle between the ball and an outer ring.

Further, before the establishing a low-speed heavy-load ball bearing model of a liquid rocket engine according to a normal contact stress of a ball bearing, the simulation method for dynamic contact characteristics of a high-speed heavy-load ball bearing in a liquid rocket engine further includes:
establishing an equation of a normal contact problem based on a semi-infinite long-space elastic Hertz theory; and
simplifying the equation of the normal contact problem with a linear least-squares regression method to obtain the normal contact stress of the heavy-load ball bearing.

Further, after simplified with the linear least-squares regression method, the equation of the normal contact problem is expressed as:

$$\frac{B - A}{B + A} = F ( ρ ) = \frac{( {e}^{2} + 1 ) M ( e ) - 2 N ( e )}{( {e}^{2} - 1 ) M ( e )}$$

$$A = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ N ( e ) - M ( e ) ]$$

$$where :$$

$$A = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ N ( e ) - M ( e ) ]$$

$$B = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ \frac{{a}^{2}}{{b}^{2}} M ( e ) - N ( e ) ]$$

$$e \approx 1.0339 {( {R}_{x} / {R}_{y} )}^{0.636}$$

$$N ( e ) \approx 1.5277 + 0.60231 n ( {R}_{y} / {R}_{x} )$$

$$M ( e ) \approx 1.0003 + 0.5968 {R}_{x} / {R}_{y}$$

where, A and B each represent a mass point on a contact surface, a is a semi-major axis of a contact ellipse, b is a semi-minor axis of the contact ellipse, e is a parameter of the contact ellipse, N(e) is a complete elliptic integral of a first kind, M(e) is a complete elliptic integral of a second kind, E₁ is an elastic modulus of the ball, E₂ is an elastic modulus of a raceway, υ₁ is a Poisson's ratio of the ball, υ₂ is a Poisson's ratio of the raceway, p₀ is a maximum compressive stress at a center of the contact ellipse, the contact ellipse being an ellipse when the ball contacts the raceway, and Rₓ and R_{y} represent equivalent radii in the semi-major axis and the semi-minor axis of the contact ellipse.

Further, the static contact characteristics of the low-speed heavy-load ball bearing include: a dimensionless radial deformation of the heavy-load ball bearing, a dimensionless axial deformation of the heavy-load ball bearing, a contact angle of the heavy-load ball bearing and an equivalent contact rigidity of the heavy-load ball bearing.

Further, the establishing a low-speed heavy-load ball bearing model of a liquid rocket engine according to a normal contact stress of a ball bearing includes:
establishing the low-speed heavy-load ball bearing model of the liquid rocket engine according to the normal contact stress of the ball bearing, without considering influences from a centrifugal force and a gyroscopic moment of the ball bearing in high-speed rotation; and
the establishing a high-speed heavy-load ball bearing model of the liquid rocket engine based on a theory of quasi-static analysis includes:
establishing the high-speed heavy-load ball bearing model of the liquid rocket engine based on the theory of quasi-static analysis, with considering the influences from the centrifugal force and the gyroscopic moment of the ball bearing in the high-speed rotation.

Further, the high-speed heavy-load ball bearing model of the liquid rocket engine is expressed as:

$${F}_{a} - {\sum }_{j = 1}^{Z} [ {Q}_{ij} sin {α}_{ij} - \frac{2 ( 1 - {λ}_{j} ) {M}_{gj}}{{D}_{w}} cos {α}_{ij} ] = 0$$

$${F}_{rx} - {\sum }_{j = 1}^{Z} [ {Q}_{ij} cos {α}_{ij} - \frac{2 ( 1 - {λ}_{j} ) {M}_{gj}}{{D}_{w}} sin {α}_{ij} ] cos {ψ}_{j} = 0$$

$${F}_{ry} - {\sum }_{j = 1}^{Z} [ {Q}_{ij} cos {α}_{ij} - \frac{2 ( 1 - {λ}_{j} ) {M}_{gj}}{{D}_{w}} sin {α}_{ij} ] sin {ψ}_{j} = 0$$

$${M}_{rx} - {\sum }_{j = 1}^{Z} [ - {Q}_{ij} cos {α}_{ij} + \frac{2 ( 1 - {λ}_{j} ) {M}_{gj}}{{D}_{w}} sin {α}_{ij} + ( {Q}_{ij} sin {α}_{ij} - \frac{2 ( 1 - {λ}_{j} ) {M}_{gj}}{{D}_{w}} cos {α}_{ij} ) {i}_{} + \frac{2 ( 1 - {λ}_{j} ) {M}_{gj}}{{D}_{w}} {r}_{i} ] sin {ψ}_{j} = 0$$

$${M}_{ry} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} - ( {Q}_{ij} sin {α}_{ij} - \frac{2 ( 1 - {λ}_{j} ) {M}_{gj}}{{D}_{w}} cos {α}_{ij} ) {i}_{} + \frac{2 ( 1 - {λ}_{j} ) {M}_{gj}}{{D}_{w}} {r}_{i} ] sin {ψ}_{j} = 0$$

where, Fᵣₓ is a force projected to an X direction from an applied radial load of the ball bearing, F_{ry} is a force projected to a Y direction from the applied radial load of the ball bearing, Fₐ is an axial load of the ball bearing, Z is a number of balls, ψⱼ is a position angle of the ball bearing, j being a jth ball in the bearing, αᵢⱼ is a contact angle between the jth ball and the inner ring, Mᵣₓ is an applied moment of the ball bearing in the X direction, M_{ry} is an applied moment of the ball bearing in the Y direction, M_{gj} is a gyroscopic moment of the jth ball, λⱼ is a distribution coefficient of a friction moment of the jth ball, Qᵢⱼ is a contact force between the jth ball and the inner ring, and [symbol] ᵢ=dₘ/2+(fᵢ−0.5)D_{w} cos αᵢⱼ dₘ/2+(fᵢ−0.5)D_{w} cos αᵢⱼ, dₘ being a pitch diameter of the ball bearing, fᵢ being a groove curvature radius coefficient of the inner ring of the bearing, D_{w}^{D}^{_{w}} being a diameter of the ball, and rᵢ being a groove curvature radius of the inner ring.

Further, the low-speed heavy-load ball bearing model of the liquid rocket engine is expressed as:

$${F}_{r} - {K}_{n} {S}_{G}^{3 / 2} {\sum }_{j = 1}^{Z} \frac{{[ \sqrt{( sin α + {\overline{u}}_{a} ) + {( cos α + {\overline{u}}_{r} cos {ψ}_{j} )}^{2}} - 1 ]}^{3 / 2} ( cos α + {\overline{u}}_{r} cos {ψ}_{j} ) cos {ψ}_{j}}{\sqrt{{( sin α + {\overline{u}}_{a} )}^{2} + {( cos α + {\overline{u}}_{r} cos {ψ}_{j} )}^{2}}} = 0$$

$${F}_{r} - {K}_{n} {S}_{G}^{3 / 2} {\sum }_{j = 1}^{Z} \frac{{[ \sqrt{( sin α + {\overline{u}}_{a} ) + {( cos α + {\overline{u}}_{r} cos {ψ}_{j} )}^{2}} - 1 ]}^{3 / 2} ( sin α + {\overline{u}}_{a} )}{\sqrt{{( sin α + {\overline{u}}_{a} )}^{2} + {( cos α + {\overline{u}}_{r} cos {ψ}_{j} )}^{2}}} = 0$$

$${M}_{r} - \frac{{d}_{m}}{2} {K}_{n} {S}_{G}^{3 / 2} {\sum }_{j = 1}^{Z} \frac{{[ \sqrt{{( sin α + \overline{{u}_{a}} )}^{2} + ( {( cos α + {\overline{u}}_{r} cos {ψ}_{j} )}^{2} )} - 1 ]}^{3 / 2} ( sin α + {\overline{u}}_{a} )}{\sqrt{{( sin α + \overline{{u}_{a}} )}^{2} + ( {( cos α + {\overline{u}}_{r} cos {ψ}_{j} )}^{2} )}}$$

where, Fᵣ is a radial load of the ball bearing, Fₐ is an axial load of the ball bearing, uᵣ and uₐ respectively are a radial deformation amount and an axial deformation amount of the ball bearing when the ball bearing is under the radial load Fᵣ and the axial load Fₐ, Kₙ^{K}^{ₙ} is an nth iteration, S_{G}^{S}^{_{G}} is a distance between groove curvature centers of the inner ring and the outer ring of the angular contact ball bearing, α is an initial contact angle of the ball bearing, Mᵣ is an applied moment on the ball bearing, and ψⱼ is the position angle of the heavy-load ball bearing, j being the jth ball in the bearing.

Further, the performing iterative operation through a dual-population CPSO algorithm includes:
step 1: setting parameters of a population s1 and a population s2, the parameters including a population size, a particle dimension, a maximum number of iterations, acceleration constants c1 and c2, and inertia weights w1 and w2, and the population s1 and the population s2 forming a dual population;
step 2: randomly initializing an initial position and an initial speed of each of particles in the population s1 and the population s2 to obtain a personal best value pbest_{id}(k) and a global best value gbest_{id}(k);
step 3: computing a fitness value of each of particles in the dual population, and synchronously updating a position and a speed of the particle, namely updating a parameter space of each of the population s1 and the population s2, a fitness value for an inertia weight of each of the population s1 and the population s2 is computed by:

$$Fitness = {\sum }_{j = 1}^{Z} ( \vert Expr 1 \vert + \vert Expr 2 \vert ) + \vert Expr 3 \vert + \vert Expr 4 \vert + \vert Expr 5 \vert$$

where, k is a present number of iterations; and
Expr1 satisfies:

$$\begin{matrix}Expr 1 = {( {X}_{2 j} - {X}_{{1}_{j}} )}^{2} + {( {Y}_{2 j} \to {Y}_{{1}_{j}} )}^{2} - {[ ( {f}_{i} - 0.5 ) {D}_{w} + {δ}_{ij} ]}^{2} \\ {X}_{2 j} = {S}_{G} sin α + {δ}_{a} + θ {i}_{} cos {ψ}_{j} \\ \text{where:} \\ {Y}_{2 j} = {S}_{G} cos α + {δ}_{r} cos {ψ}_{j}\end{matrix}$$

X₁ⱼ and Y₁ⱼ are solved by:

$$\begin{matrix}{{( {X}_{2 j} - {X}_{1 j} )}^{2} + {( {Y}_{2 j} - {Y}_{{1}_{J}} )}^{2} - ( {f}_{i} - 0. 5 ) {D}_{w} + {δ}_{ij} ]}^{2} = 0 \\ {X}_{1 j}^{2} + {X}_{ij}^{2} - {[ ( {f}_{o} - 0.5 ) {D}_{w} + {δ}_{oj} ]}^{2} = 0\end{matrix}$$

X₁ⱼ, Y₁ⱼ, X₂ⱼ, and Y₂ⱼ are geometrical quantities changed in position of a curvature center before and after the ball bearing is loaded, da is an axial deformation of the ball bearing under an axial force Fₐ, δ^{δ}ᵣ is a radial deformation of the ball bearing under a radial force Fᵣ, θ is a rotating angle of the ball bearing under a moment M, fᵢ is a groove curvature radius coefficient of the inner ring of the ball bearing, f₀ is a groove curvature radius coefficient of the outer ring of the ball bearing, δᵢⱼ and δₒⱼ are contact deformations of a jth ball with the inner and outer rings of the ball bearing, S_{G} is a distance between groove curvature centers of the inner and outer rings of the ball bearing, and Expr2, Expr3, Expr4, and Expr5 satisfy:

$$\begin{matrix}Expr 2 = {X}_{1 j}^{2} + {Y}_{1 j}^{2} - {[ ( {f}_{o} - 0.5 ) {D}_{w} + {δ}_{oj} ]}^{2} \\ Expr 3 = {F}_{a} - {\sum }_{j = 1}^{Z} [ {Q}_{ij} sin {α}_{ij} + \frac{2 ( 1 - {λ}_{j} ) {M}_{gj}}{{D}_{w}} cos {α}_{ij} ] \\ Expr 4 = {F}_{r} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ] \\ Expr 5 = {M}_{y} - {\sum }_{j = 1}^{Z} [ ( {Q}_{ij} sin {α}_{ij} - \frac{2 ( 1 - {λ}_{j} ) {M}_{gj}}{{D}_{b}} cos {α}_{ij} ) {i}_{} + \frac{2 ( 1 - {λ}_{j} ) {M}_{gj}}{{D}_{b}} {r}_{i} ] cos {ψ}_{j} ;\end{matrix}$$

and the speed and the position of the particle are updated by:

$${v}_{id} ( k + 1 ) = w \cdot {v}_{id} ( k ) + {c}_{1} \cdot {r}_{1} \cdot [ {pbest}_{id} ( k ) - {x}_{id} ( k ) ] + {c}_{2} \cdot {r}_{2} \cdot [ {pbest}_{id} ( k ) - {x}_{id} ( k ) ]$$

$${x}_{id} ( k + 1 ) = {x}_{id} ( k ) + {v}_{id} ( k + 1 )$$

where, i=1, 2, . . . , m is an updated algebra; d=1, 2, . . . , D is a dimension of a search space, D being a number of unknowns in a fitness equation; v_{id}(k) and v_{id}(k+1) are a present speed and an updated speed of ith and (i+1)th generations of particle swarms, x_{id}(k) and x_{id}(k+1) are a present position and an updated position of the ith and (i+1)th generations of particle swarms, pbest_{id}(k) is a personal best value searched for the particle, gbest_{id}(k) is a global best value searched for the population, w is an inertia weight, represents an influence of the particle on a present speed, and has a capability of balancing global convergence and local convergence, c₁ and c₂ each are an acceleration constant, and represent an acceleration weight of a position for pushing the particle to the personal best value and the global best value; and r₁ and r₂ each are a random number within [0, 1];
step 4: updating a personal best value and a global best value of the dual population, comparing each of the particles in the population s1 and the population s2 with a present personal best value according to the fitness value, and selecting an optimal personal best value pbest_{id}(k) and a global best value gbest_{id}(k) having a minimum fitness value;
step 5: employing a dynamic cooperation strategy of the dual population, establishing a cooperative relationship through a neighborhood model, and sharing a personal best value and a global best value searched by each of the populations in the dual population;
step 6: determining an algorithm termination condition, terminating, if a present number of iterations is up to the maximum number of iterations, circulation and considering that optimization on the contact angle between the ball and the inner ring in the ball bearing is accomplished, or otherwise, going back to step 3 for continuous iterative operation; and
step 7: obtaining the contact angle between the ball and the outer ring through an optimized contact angle between the ball and the inner ring in step 6 and according to a mathematic relationship between the contact angle of the inner ring and the contact angle of the outer ring, thereby completing simulation on the dynamic contact characteristics of the high-speed heavy-load ball bearing.

Further, when the iterative computation is performed on the low-speed heavy-load ball bearing model of the liquid rocket engine, a Newton-Raphson iterative method is used.

Further, the ball bearing has a DN value of ≥2.5×10⁶ mm·r/min, and a ratio of a dynamic equivalent radial load Pr of the ball bearing to a dynamic load rating Cr of the ball bearing is >0.15.

Compared with the prior art, the present disclosure has the following beneficial effects:
(1) According to the present disclosure, in response to computation of the normal contact stress of the ball bearing, as the parameter e of the contact ellipse approaches to 1, the elliptic integral is converged slowly. By virtue of the linear least-squares regression method, an approximate equation with respect to e, N (e) and M (e) can be obtained to greatly simplify computation on a transcendental equation.
(2) The model involves a number of nonlinear equations, which are hardly converged by a conventional numerical solution method to an accurate solution. In order to solve complicated optimization such as nonlinear, indifferentiable and multi-peak problems, the present disclosure first introduces the dual-population CPSO algorithm to an analysis model of the ball bearing, and searches a solution space in parallel with multiple populations, thereby effectively solving the problem that the conventional method is prone to a personal best value for lack of population diversity. Meanwhile, since searched best values of the populations can be shared, the present disclosure effectively improves the search speed of the population.

### BRIEF DESCRIPTION OF THE DRAWINGS

In order to more clearly illustrate technical solutions in the embodiments of the present disclosure or in the prior art, the drawings required for the description of the embodiments or the prior art will be provided below.

FIG. 1 is an implementation flowchart of a method according to the present disclosure;

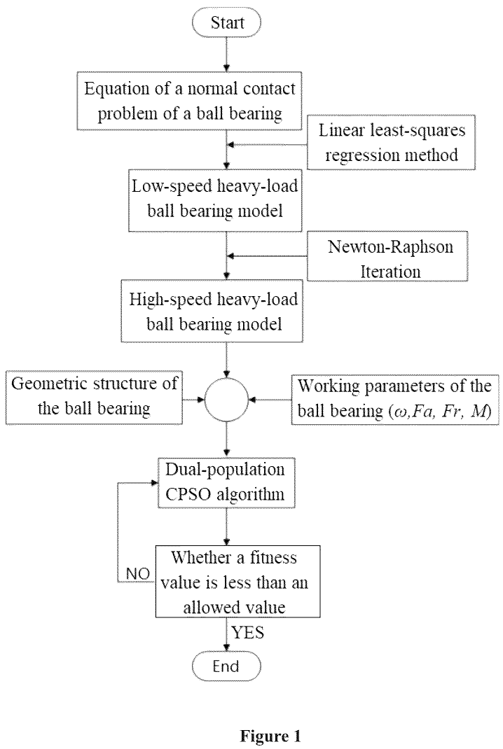

FIG. 2 is a curve graph illustrating that a contact angle of an inner ring changes with an axial load; and

FIG. 3 is a curve graph illustrating that a contact angle of an outer ring changes with an axial load.

### DETAILED DESCRIPTION OF THE EMBODIMENTS

The present disclosure provides a simulation method for dynamic contact characteristics of a high-speed heavy-load ball bearing in a liquid rocket engine. The simulation process is executed on a matlab, and specifically includes the following steps:
Step 1: Establish an equation of a normal contact problem based on a semi-infinite long-space elastic Hertz theory, simplify the equation in combination with a linear least-squares regression method, and obtain a normal contact stress of a ball bearing.

The simplified equation of the normal contact problem is expressed as:

$$\frac{B - A}{B + A} = F ( ρ ) = \frac{( {e}^{2} + 1 ) M ( e ) - 2 N ( e )}{( {e}^{2} - 1 ) M ( e )}$$

$$A = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ N ( e ) - M ( e ) ]$$

$$where :$$

$$B = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ \frac{{a}^{2}}{{b}^{2}} M ( e ) - N ( e ) ]$$

$$e \approx 1.0339 {( {R}_{x} / {R}_{y} )}^{0.636}$$

$$N ( e ) \approx 1.5277 + 0.60231 n ( {R}_{y} / {R}_{x} )$$

$$M ( e ) \approx 1.0003 + 0.5968 {R}_{x} / {R}_{y}$$

where, A and B each represent a mass point on a contact surface, a is a semi-major axis of a contact ellipse, b is a semi-minor axis of the contact ellipse, e is a parameter of the contact ellipse, N(e) is a complete elliptic integral of a first kind, M(e) is a complete elliptic integral of a second kind, E₁ is an elastic modulus of each of balls, E₂ is an elastic modulus of a raceway, υ₁ is a Poisson's ratio of the ball, υ₂ is a Poisson's ratio of the raceway, p₀ is a maximum compressive stress at a center of the contact ellipse, the contact ellipse being an ellipse when the ball contacts the raceway, and Rₓ and R_{y} represent equivalent radii in the semi-major axis and the semi-minor axis of the contact ellipse.

Step 2: Establish a low-speed heavy-load ball bearing model of a liquid rocket engine according to the normal contact stress, without considering influences from a centrifugal force and a gyroscopic moment in high-speed rotation. In the embodiment, a Newton-Raphson iterative method is used to compute static contact characteristics of the ball bearing. The static contact characteristics of the ball bearing include a dimensionless radial deformation of the ball bearing, a dimensionless axial deformation of the ball bearing, a contact angle α of the ball bearing and an equivalent contact rigidity Kn of the ball bearing.

The low-speed heavy-load ball bearing model of the liquid rocket engine is expressed as:

$${F}_{r} - {K}_{n} {S}_{G}^{3 / 2} {\sum }_{j = 1}^{Z} \frac{{[ \sqrt{\begin{matrix}{( sin α + {\overline{u}}_{a} )}^{2} + \\ {( cos α + {\overline{u}}_{r} cos {ψ}_{j} )}^{2}\end{matrix}} - 1 ]}^{3 / 2} ( cos α + {\overline{u}}_{r} cos {ψ}_{j} ) cos {ψ}_{j}}{\sqrt{{( sin α + {\overline{u}}_{a} )}^{2} + {( cos α + {\overline{u}}_{r} cos {ψ}_{j} )}^{2}}} = 0$$

$${F}_{a} - {K}_{n} {S}_{G}^{3 / 2} {\sum }_{j = 1}^{Z} \frac{{[ \sqrt{{( sin α + {\overline{u}}_{a} )}^{2} + {( cos α + {\overline{u}}_{r} cos {ψ}_{j} )}^{2}} - 1 ]}^{3 / 2} ( sin α + {\overline{u}}_{a} )}{\sqrt{{( sin α + {\overline{u}}_{a} )}^{2} + {( cos α + {\overline{u}}_{r} cos {ψ}_{j} )}^{2}}} = 0$$

$${M}_{r} - \frac{{d}_{m}}{2} {K}_{n} {S}_{G}^{3 / 2} {\sum }_{j = 1}^{Z} \frac{{[ \sqrt{\begin{matrix}{( sin α + \overline{{μ}_{a}} )}^{2} + \\ ( {( cos α + \overline{{μ}_{r}} cos {ψ}_{j} )}^{2} )\end{matrix}} - 1 ]}^{3 / 2} ( sin α + \overline{{μ}_{a}} ) cos {ψ}_{j}}{\sqrt{{( sin α + \overline{{μ}_{a}} )}^{2} + ( {( cos α + \overline{{μ}_{r}} cos {ψ}_{j} )}^{2} )}} = 0$$

where, Fᵣ is a radial load of the ball bearing, Fₐ is an axial load of the ball bearing, uᵣ and uₐ respectively are a radial deformation amount and an axial deformation amount of the ball bearing when the ball bearing is under the radial load Fᵣ and the axial load Fₐ, Kₙ is an nth iteration, S_{G} is a distance between groove curvature centers of the inner ring and the outer ring of the angular contact ball bearing, a is an initial contact angle of the ball bearing, Mᵣ is an applied moment on the ball bearing, and ψⱼ is a position angle of the heavy-load ball bearing, j being a jth ball in the bearing.

Step 3: Establish a high-speed heavy-load ball bearing model of the liquid rocket engine based on a theory of quasi-static analysis in a same condition as Step 2, with considering the influences from the centrifugal force and the gyroscopic moment in the high-speed rotation.

The high-speed heavy-load ball bearing model of the liquid rocket engine is expressed as:

$${F}_{a} - {\sum }_{j = 1}^{Z} [ {Q}_{ij} sin {α}_{ij} - \frac{2 ( 1 - {λ}_{j} ) {M}_{gj}}{{D}_{w}} cos {α}_{ij} ] = 0$$

$${F}_{rx} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ] cos {ψ}_{j} = 0$$

$${F}_{ry} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ] sin {ψ}_{j} = 0$$

$${M}_{rx} - {\sum }_{j = 1}^{Z} [ - {Q}_{ij} cos {α}_{ij} + \frac{2 ( 1 - {λ}_{j} ) {M}_{gj}}{{D}_{w}} sin {α}_{ij} + ( {Q}_{ij} sin {α}_{ij} - \frac{2 ( 1 - {λ}_{j} ) {M}_{gj}}{{D}_{w}} cos {α}_{ij} ) {ℛ}_{i} + \frac{2 ( 1 - {λ}_{j} ) {M}_{gj}}{{D}_{w}} {r}_{i} ] sin {ψ}_{j} = 0$$

$${M}_{ry} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} - ( {Q}_{ij} sin {α}_{ij} - \frac{2 ( 1 - {λ}_{j} ) {M}_{gj}}{{D}_{w}} cos {α}_{ij} ) {ℛ}_{i} - \frac{2 ( 1 - {λ}_{j} ) {M}_{gj}}{{D}_{w}} {r}_{i} ] cos {ψ}_{j} = 0$$

where, Fᵣₓ is a force projected to an X direction from an applied radial load of the ball bearing, F_{ry} is a force projected to a Y direction from the applied radial load of the ball bearing, Fₐ is an axial load of the ball bearing, Z is a number of the balls, ψⱼ is the position angle of the ball bearing, j being the jth ball in the bearing, oj is a contact angle between the jth ball and the inner ring, Mᵣₓ is an applied moment of the ball bearing in the X direction, M_{ry} is an applied moment of the ball bearing in the Y direction, M_{gi} is a gyroscopic moment of the jth ball, λⱼ is a distribution coefficient of a friction moment of the jth ball, Qᵢⱼ is a contact force between the jth ball and the inner ring, and [symbol] ᵢdₘ/2+(fᵢ−0.5)D_{w} cos αᵢⱼ, dₘ being a pitch diameter of the ball bearing, fᵢ^{f}^{ᵢ} being a groove curvature radius coefficient of the inner ring of the bearing, D_{w}^{D}^{_{w}} being a diameter of the ball, and rᵢ being a groove curvature radius of the inner ring.
Step 4: Take computed values for the static contact characteristics of the low-speed heavy-load ball bearing as an initial value, substitute the initial values into the high-speed heavy-load ball bearing model, and perform iterative operation through a dual-population CPSO algorithm to obtain dynamic contact characteristics of the ball, where the dynamic contact characteristic includes a contact angle between the ball and an inner ring, and a contact angle between the ball and an outer ring.

The CPSO algorithm uses multiple populations for parallel search. During each iteration, different evolutionary mechanisms are used, which facilitates global search as well as quick convergence to a best value in a late period of the search.

The step of performing iterative operation through a dual-population CPSO algorithm specifically includes:
Step 4.1: Set populations s1 and s2, including a population size, a particle dimension, a maximum number of iterations, acceleration constants c1 and c2, and inertia weights w1 and w2.
Step 4.2: Randomly initialize an initial position and an initial speed of each of particles in the populations to obtain a personal best value pbest_{id}(k) and a global best value gbest_{id}(k)
Step 4.3: Compute a fitness value of each of particles in a dual population, and synchronously update a position and a speed of the particle, namely updating a parameter space of each of the populations.

A fitness value for an inertia weight of each of the populations is computed by:

$$Fitness = {\sum }_{j = 1}^{Z} ( \vert Expr 1 \vert + \vert Expr 2 \vert ) + \vert Expr 3 \vert + \vert Expr 4 \vert + \vert Expr 5 \vert$$

where, k is a present number of iterations.

Expr1 satisfies:

$$Expr 1 = {( {X}_{2 j} - {X}_{1 j} )}^{2} + {( {Y}_{2 j} - {Y}_{1 j} )}^{2} - {[ ( {f}_{i} - 0.5 ) {D}_{w} + {δ}_{ij} ]}^{2}$$

$$where : {X}_{2 j} = {S}_{G} sin α + {δ}_{a} + θ {ℛ}_{i} cos {ψ}_{j}$$

$${Y}_{2 j} = {S}_{G} cos α + {δ}_{r} cos {ψ}_{j} .$$

X₁ⱼ and Y₁ⱼ are solved by:

$${( {X}_{2 j} - {X}_{1 j} )}^{2} + {( {Y}_{2 j} - {Y}_{1 j} )}^{2} - {[ ( {f}_{i} - 0.5 ) {D}_{w} + {δ}_{ij} ]}^{2} = 0$$

$${{X}_{1 j}^{2} + {Y}_{1 j}^{2} - [ {f}_{o} - 0.5 ) {D}_{w} + {δ}_{oj} ]}^{2} = 0$$

where, X₁ⱼ, Y₁ⱼ, X₂ⱼ, and Y₂ⱼ are geometrical quantities changed in position of a curvature center before and after the ball bearing is loaded, ^{δ}δₐ is an axial deformation of the ball bearing under an axial force Fₐ, δ^{δ}ᵣ is a radial deformation of the ball bearing under a radial force Fᵣ, ^{θ}θ is a rotating angle of the ball bearing under a moment M, fᵢ is a groove curvature radius coefficient of the inner ring of the ball bearing, f₀ is a groove curvature radius coefficient of the outer ring of the ball bearing, δᵢⱼ and δₒⱼ are contact deformations of a j^{th} ball with the inner and outer rings of the ball bearing, S_{G} is a distance between groove curvature centers of the inner and outer rings of the ball bearing, and Expr2, Expr3, Expr4, and Expr5 satisfy:

$$Expr 2 = {X}_{1 j}^{2} + {Y}_{1 j}^{2} - {[ ( {f}_{o} - 0.5 ) {D}_{w} + {δ}_{oj} ]}^{2} ;$$

$$Expr 3 = {F}_{a} - {\sum }_{j = 1}^{Z} [ {Q}_{ij} sin {α}_{ij} - \frac{2 ( 1 - {λ}_{j} ) {M}_{gj}}{{D}_{w}} cos {α}_{ij} ]$$

$$Expr 4 = {F}_{r} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ]$$

$$Expr 5 = {M}_{y} - {\sum }_{j = 1}^{Z} [ ( {Q}_{ij} sin {α}_{ij} - \frac{2 ( 1 - {λ}_{j} ) {M}_{gj}}{{D}_{b}} cos {α}_{ij} ) {ℛ}_{i} + \frac{2 ( 1 - {λ}_{j} ) {M}_{gj}}{{D}_{b}} {r}_{i} ] cos {ψ}_{j} .$$

The speed and the position of the particle are updated by:

$${v}_{id} ( k + 1 ) = w \cdot {v}_{id} ( k ) + {c}_{1} \cdot {r}_{1} \cdot [ {pbest}_{id} ( k ) - {x}_{id} ( k ) ] + {c}_{2} \cdot {r}_{2} \cdot [ {gbest}_{id} ( k ) - {x}_{id} ( k ) ]$$

$${x}_{id} ( k + 1 ) = {x}_{id} ( k ) + {v}_{id} ( k + 1 )$$

where, i=1, 2, . . . , m is an updated algebra; d=1, 2, . . . , D is a dimension of a search space, D being a number of unknowns in a fitness equation; v_{id}(k) and v_{id}(k+1) are a present speed and an updated speed of ith and (i+1)th generations of particle swarms, x_{id}(k) and x_{id}(k+1) are a present position and an updated position of the ith and (i+1)th generations of particle swarms, pbest_{id}(k) is a personal best value searched for the particle, gbest_{id}(k) is a global best value searched for the population, w is an inertia weight, represents an influence of the particle on a present speed, and has a capability of balancing global convergence and local convergence, c₁ and c₂ each are an acceleration constant, and represent an acceleration weight of a position for pushing the particle to the personal best value and the global best value; and r₁ and r₂ each are a random number within [0, 1].
Step 4.4: Update a personal best value and a global best value of the dual population, compare each of the particles in the dual population with a present personal best value according to the fitness value, and select an optimal personal best value pbest_{id}(k) and a global best value gbest_{id}(k) having a minimum fitness value.
Step 4.5: Employ a dynamic cooperation strategy of the dual population, establish a cooperative relationship through a neighborhood model, and share a personal best value and a global best value searched by each of the populations.
Step 4.6: Determine an algorithm termination condition, terminate, if a present number of iterations is up to the maximum number of iterations, circulation and consider that optimization on the contact angle between the ball and the inner ring is accomplished, or otherwise, go back to Step 4.3 for continuous iterative operation.
Step 4.7: Obtain the contact angle between the ball and the outer ring through an optimized contact angle between the ball and the inner ring in Step 4.6 and according to a mathematic relationship between the contact angle of the inner ring and the contact angle of the outer ring, thereby completing simulation on the dynamic contact characteristics of the high-speed heavy-load ball bearing.

### Comparison and Verification:

In order to verify feasibility and accuracy of the method provided by the present disclosure in simulation of the dynamic characteristics of the high-speed heavy-load ball bearing, an angular contact ball bearing B218 is selected, with main structural parameters shown in Table 1. The inner ring, outer ring and ball are all made of GCr15 steel.

TABLE 1
Structural parameters of angular contact ball bearing B218

| Parameter | Unit | Value |
|---|---|---|
| Inner diameter Dᵢ of bearing | mm | 90.00 |
| Outer diameter D₀ of bearing | mm | 160.00 |
| Diameter dᵢ of inner ring raceway | mm | 102.80 |
| Diameter d₀ of outer ring raceway | mm | 147.40 |
| Groove curvature radius rᵢ of inner ring | mm | 11.63 |
| Groove curvature radius r₀ of outer ring | mm | 11.63 |
| Diameter D_{w} of ball | mm | 22.23 |
| Initial contact angle | degree | 40 |
| Number Z of balls | Pieces | 16 |

In response to the axial load 17.8 kN and different rotational speeds, solving a nonlinear equation set of the high-speed heavy-load ball bearing model with the simulation method of the present disclosure can obtain inner and outer contact angles of the angular contact ball bearing B218. Comparisons between computed values and experimental values are shown in the table below. As can be seen from Table 2, the maximum relative error between the simulated value and the experimental value in the contact angles of the inner and outer rings of the angular contact ball bearing B218 is 5.680%. Therefore, the simulation method is highly precise, and can meet requirements of analysis on the dynamic characteristic of the high-speed heavy-load ball bearing.

TABLE 2
Comparison between computed value and literature value in contact
angle of the ball bearing B218 when the axial force is 17.8 kN

| | Outer contact angle α^{α}₀/(°) | | | Inner contact angle αᵢ/(°) | | |
|---|---|---|---|---|---|---|
| Rotational | | Experi- | | | Experi- | |
| speed n/ | Computed | mental | | Computed | mental | |
| (r · min⁻¹) | value | value | Error | value | value | Error |
| 3000 | 40.258 | 40.671 | 1.015% | 42.979 | 42.328 | 1.538% |
| 6000 | 39.083 | 38.060 | 2.688% | 44.749 | 44.749 | 2.043% |
| 10000 | 32.672 | 31.368 | 4.157% | 50.056 | 50.056 | 3.188% |
| 15000 | 20.280 | 19.190 | 5.680% | 57.012 | 57.012 | 5.132% |

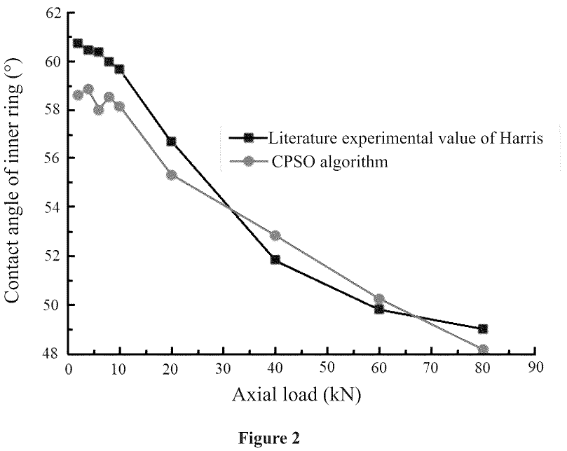

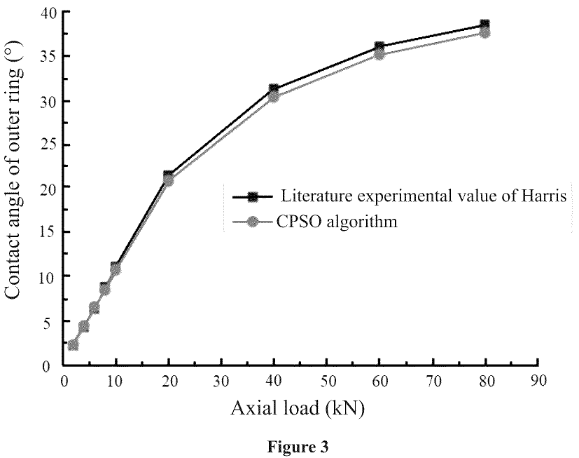

In response to the rotational speed n=15000 r/min of the bearing and different axial loads, the changing curves for the inner and outer contact angles of the angular contact ball bearing B218 and for the computed values are as shown in FIG. 2 and FIG. 3. As can be seen, the tendency of simulated values on contact angles of the inner and outer rings of the ball bearing B218 is in well agreement with that of experimental values, the maximum relative simulation error is 5.128%, and as the axial force increases, the relative simulation error for the contact angles of the inner and outer rings decreases and can be 2.376%, all of which verify the optimization capability and error reduction of the algorithm.

1. A simulation method for dynamic contact characteristics of a high-speed heavy-load ball bearing in a liquid rocket engine, comprising the following steps:
establishing a low-speed heavy-load ball bearing model of a liquid rocket engine according to a normal contact stress of a ball bearing, and performing iterative computation on the low-speed heavy-load ball bearing model of the liquid rocket engine to obtain static contact characteristics of the low-speed heavy-load ball bearing;
establishing a high-speed heavy-load ball bearing model of the liquid rocket engine based on a theory of quasi-static analysis; and
taking computed values for the static contact characteristics of the low-speed heavy-load ball bearing as initial values, substituting the initial values into the high-speed heavy-load ball bearing model, and performing iterative operation through a dual-population co-evolutionary particle swarm optimization (CPSO) algorithm to obtain dynamic contact characteristics of each of balls in the ball bearing, wherein the dynamic contact characteristics comprise a contact angle between the ball and an inner ring, and a contact angle between the ball and an outer ring.

2. The simulation method for dynamic contact characteristics of a high-speed heavy-load ball bearing in a liquid rocket engine according to claim 1, before the establishing a low-speed heavy-load ball bearing model of a liquid rocket engine according to a normal contact stress of a ball bearing, further comprising:
establishing an equation of a normal contact problem based on a semi-infinite long-space elastic Hertz theory; and
simplifying the equation of the normal contact problem with a linear least-squares regression method to obtain the normal contact stress of the heavy-load ball bearing.

3. The simulation method for dynamic contact characteristics of a high-speed heavy-load ball bearing in a liquid rocket engine according to claim 2, wherein after simplified with the linear least-squares regression method, the equation of the normal contact problem is expressed as:
$$\frac{B - A}{B + A} = F ( ρ ) = \frac{( {e}^{2} + 1 ) M ( e ) - 2 N ( e )}{( {e}^{2} - 1 ) ( M ( e )}$$
$$wherein : A = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ N ( e ) - M ( e ) ]$$
$$B = \frac{{bp}_{0}}{{a}^{2} {e}^{2}} ( \frac{1 - {v}_{1}^{2}}{π {E}_{1}} + \frac{1 - {v}_{2}^{2}}{π {E}_{2}} ) [ \frac{{a}^{2}}{{b}^{2}} M ( e ) - N ( e ) ]$$
$$e \approx 1.0339 {( {R}_{x} / {R}_{y} )}^{0.636}$$
$$N ( e ) \approx 1.5277 + 0.60231 n ( {R}_{y} / {R}_{x} )$$
$$M ( e ) \approx 1.0003 + 0.5968 {R}_{x} / {R}_{y}$$
wherein, A and B each represent a mass point on a contact surface, a is a semi-major axis of a contact ellipse, b is a semi-minor axis of the contact ellipse, e is a parameter of the contact ellipse, N(e) is a complete elliptic integral of a first kind, M(e) is a complete elliptic integral of a second kind, E₁ is an elastic modulus of the ball, E₂ is an elastic modulus of a raceway, υ₁ is a Poisson's ratio of the ball, υ₂ is a Poisson's ratio of the raceway, p₀ is a maximum compressive stress at a center of the contact ellipse, the contact ellipse being an ellipse when the ball contacts the raceway, and Rₓ and R_{y} represent equivalent radii in the semi-major axis and the semi-minor axis of the contact ellipse.

4. The simulation method for dynamic contact characteristics of a high-speed heavy-load ball bearing in a liquid rocket engine according to claim 1, wherein the static contact characteristics of the low-speed heavy-load ball bearing comprises: a dimensionless radial deformation of the heavy-load ball bearing, a dimensionless axial deformation of the heavy-load ball bearing, a contact angle of the heavy-load ball bearing and an equivalent contact rigidity of the heavy-load ball bearing.

5. The simulation method for dynamic contact characteristics of a high-speed heavy-load ball bearing in a liquid rocket engine according to claim 1, wherein the establishing a low-speed heavy-load ball bearing model of a liquid rocket engine according to a normal contact stress of a ball bearing comprises:
establishing the low-speed heavy-load ball bearing model of the liquid rocket engine according to the normal contact stress of the ball bearing, without considering influences from a centrifugal force and a gyroscopic moment of the ball bearing in high-speed rotation; and
the establishing a high-speed heavy-load ball bearing model of the liquid rocket engine based on a theory of quasi-static analysis comprises:
establishing the high-speed heavy-load ball bearing model of the liquid rocket engine based on the theory of quasi-static analysis, with considering the influences from the centrifugal force and the gyroscopic moment of the ball bearing in the high-speed rotation.

6. The simulation method for dynamic contact characteristics of a high-speed heavy-load ball bearing in a liquid rocket engine according to claim 1, wherein the high-speed heavy-load ball bearing model of the liquid rocket engine is expressed as:
$${F}_{a} - {\sum }_{j = 1}^{Z} [ {Q}_{ij} sin {α}_{ij} - \frac{2 ( 1 - {λ}_{j} ) {M}_{gj}}{{D}_{w}} cos {α}_{ij} ] = 0$$
$${F}_{rx} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ] cos {ψ}_{j} = 0$$
$${F}_{ry} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ] sin {ψ}_{j} = 0$$
$${M}_{rx} - {\sum }_{j = 1}^{Z} [ - {Q}_{ij} cos {α}_{ij} + \frac{2 ( 1 - {λ}_{j} ) {M}_{gj}}{{D}_{w}} sin {α}_{ij} + ( {Q}_{ij} sin {α}_{ij} - \frac{2 ( 1 - {λ}_{j} ) {M}_{gj}}{{D}_{w}} cos {α}_{ij} ) {ℛ}_{i} + \frac{2 ( 1 - {λ}_{j} ) {M}_{gj}}{{D}_{w}} {r}_{i} ] sin {ψ}_{j} =$$
$${M}_{ry} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} - ( {Q}_{ij} sin {α}_{ij} - \frac{2 ( 1 - {λ}_{j} ) {M}_{gj}}{{D}_{w}} cos {α}_{ij} ) {ℛ}_{i} - \frac{2 ( 1 - {λ}_{j} ) {M}_{gj}}{{D}_{w}} {r}_{i} ] cos {ψ}_{j} = 0$$
wherein, Fᵣₓ is a force projected to an X direction from an applied radial load of the ball bearing, F_{ry} is a force projected to a Y direction from the applied radial load of the ball bearing, Fₐ is an axial load of the ball bearing, Z is a number of the balls, ψⱼ is a position angle of the ball bearing, j being a jth ball in the bearing, αᵢⱼ is a contact angle between the jth ball and the inner ring, Mᵣₓ is an applied moment of the ball bearing in the X direction, M_{ry} is an applied moment of the ball bearing in the Y direction, M_{gj} is a gyroscopic moment of the jth ball, λⱼ is a distribution coefficient of a friction moment of the jth ball, Qᵢⱼ is a contact force between the jth ball and the inner ring, and [symbol] dₘ/2+(fᵢ−0.5)D_{w} cos αᵢⱼ=dₘ/2+(fᵢ−0.5)D_{w} cos αᵢⱼ, dₘ being a pitch diameter of the ball bearing, fᵢ being a groove curvature radius coefficient of the inner ring of the bearing, D_{w}^{D}^{_{w}} being a diameter of the ball, and rᵢ being a groove curvature radius of the inner ring.

7. The simulation method for dynamic contact characteristics of a high-speed heavy-load ball bearing in a liquid rocket engine according to claim 6, wherein
the low-speed heavy-load ball bearing model of the liquid rocket engine is expressed as:
$${F}_{r} - {K}_{n} {S}_{G}^{3 / 2} {\sum }_{j = 1}^{Z} \frac{{[ \sqrt{\begin{matrix}{( sin α + {\overline{u}}_{a} )}^{2} + \\ {( cos α + {\overline{u}}_{r} cos {ψ}_{j} )}^{2}\end{matrix}} - 1 ]}^{3 / 2} ( cos α + {\overline{u}}_{r} cos {ψ}_{j} ) cos {ψ}_{j}}{\sqrt{{( sin α + {\overline{u}}_{a} )}^{2} + {( cos α + {\overline{u}}_{r} cos {ψ}_{j} )}^{2}}} = 0$$
$${F}_{a} - {K}_{n} {S}_{G}^{3 / 2} {\sum }_{j = 1}^{Z} \frac{{[ \sqrt{{( sin α + {\overline{u}}_{a} )}^{2} + {( cos α + {\overline{u}}_{r} cos {ψ}_{j} )}^{2}} - 1 ]}^{3 / 2} ( sin α + {\overline{u}}_{a} )}{\sqrt{{( sin α + {\overline{u}}_{a} )}^{2} + {( cos α + {\overline{u}}_{r} cos {ψ}_{j} )}^{2}}} = 0$$
$${M}_{r} - \frac{{d}_{m}}{2} {K}_{n} {S}_{G}^{3 / 2} {\sum }_{j = 1}^{Z} \frac{{[ \sqrt{\begin{matrix}{( sin α + \overline{{μ}_{a}} )}^{2} + \\ ( {( cos α + \overline{{μ}_{r}} cos {ψ}_{j} )}^{2} )\end{matrix}} - 1 ]}^{3 / 2} ( sin α + \overline{{μ}_{a}} ) cos {ψ}_{j}}{\sqrt{{( sin α + \overline{{μ}_{a}} )}^{2} + ( {( cos α + \overline{{μ}_{r}} cos {ψ}_{j} )}^{2} )}} = 0$$
wherein, Fᵣ is a radial load of the ball bearing, Fₐ is an axial load of the ball bearing, uᵣ and uₐ respectively are a radial deformation amount and an axial deformation amount of the ball bearing when the ball bearing is under the radial load Fᵣ and the axial load Fₐ, Kₙ is an nth iteration, S_{G}^{S}^{_{G}} is a distance between groove curvature centers of the inner ring and the outer ring of the angular contact ball bearing, α is an initial contact angle of the ball bearing, Mᵣ is an applied moment on the ball bearing, and ψⱼ is the position angle of the heavy-load ball bearing, j being the jth ball in the bearing.

8. The simulation method for dynamic contact characteristics of a high-speed heavy-load ball bearing in a liquid rocket engine according to claim 1, wherein the performing iterative operation through a dual-population CPSO algorithm comprises:
step 1: setting parameters of a population s1 and a population s2, the parameters comprising a population size, a particle dimension, a maximum number of iterations, acceleration constants c1 and c2, and inertia weights w1 and w2, and the population s1 and the population s2 forming a dual population;
step 2: randomly initializing an initial position and an initial speed of each of particles in the population s1 and the population s2 to obtain a personal best value pbest_{id}(k) and a global best value gbest_{id}(k);
step 3: computing a fitness value of each of particles in the dual population, and synchronously updating a position and a speed of the particle, namely updating a parameter space of each of the population s1 and the population s2, a fitness value for an inertia weight of each of the population s1 and the population s2 is computed by:
$$Fitness = {\sum }_{j = 1}^{Z} ( \vert Expr 1 \vert + \vert Expr 2 \vert ) + \vert Expr 3 \vert + \vert Expr 4 \vert + \vert Expr 5 \vert$$
wherein, k is a present number of iterations; and
Expr1 satisfies:
$$Expr 1 = {( {X}_{2 j} - {X}_{1 j} )}^{2} + {( {Y}_{2 j} - {Y}_{1 j} )}^{2} - {[ ( {f}_{i} - 0.5 ) {D}_{w} + {δ}_{ij} ]}^{2}$$
$$wherein : {X}_{2 j} = {S}_{G} sin α + {δ}_{a} + θ {ℛ}_{i} cos {ψ}_{j}$$
$${Y}_{2 j} = {S}_{G} cos α + {δ}_{r} cos {ψ}_{j}$$
X₁ⱼ and Y₁ⱼ are solved by:
$${( {X}_{2 j} - {X}_{1 j} )}^{2} + {( {Y}_{2 j} - {Y}_{1 j} )}^{2} - {[ ( {f}_{i} - 0.5 ) {D}_{w} + {δ}_{ij} ]}^{2} = 0$$
$${{X}_{1 j}^{2} + {Y}_{1 j}^{2} - [ {f}_{o} - 0.5 ) {D}_{w} + {δ}_{oj} ]}^{2} = 0$$
wherein, X₁ⱼ, Y₁ⱼ, X₂ⱼ, and Y₂ⱼ are geometrical quantities changed in position of a curvature center before and after the ball bearing is loaded, δₐ is an axial deformation of the ball bearing under an axial force Fₐ, δ^{δ}ᵣ is a radial deformation of the ball bearing under a radial force Fᵣ, θ is a rotating angle of the ball bearing under a moment M, ^{f}ᵢ is a groove curvature radius coefficient of the inner ring of the ball bearing, f₀ is a groove curvature radius coefficient of the outer ring of the ball bearing, δᵢⱼ and δₒⱼ are contact deformations of a jth ball with the inner and outer rings of the ball bearing, S_{G} is a distance between groove curvature centers of the inner and outer rings of the ball bearing, and Expr2, Expr3, Expr4, and Expr5 satisfy:
$$Expr 2 = {X}_{1 j}^{2} + {Y}_{1 j}^{2} - {[ ( {f}_{o} - 0.5 ) {D}_{w} + {δ}_{oj} ]}^{2}$$
$$Expr 3 = {F}_{a} - {\sum }_{j = 1}^{Z} [ {Q}_{ij} sin {α}_{ij} - \frac{2 ( 1 - {λ}_{j} ) {M}_{gj}}{{D}_{w}} cos {α}_{ij} ]$$
$$Expr 4 = {F}_{r} - {\sum }_{j = 1}^{Z} [ {Q}_{ij} cos {α}_{ij} + \frac{2 ( 1 - {λ}_{j} ) {M}_{gj}}{{D}_{w}} sin {α}_{ij} ]$$
$$Expr 5 = {M}_{y} - {\sum }_{j = 1}^{Z} [ ( {Q}_{ij} sin {α}_{ij} - \frac{2 ( 1 - {λ}_{j} ) {M}_{gj}}{{D}_{b}} cos {α}_{ij} ) {ℛ}_{i} + \frac{2 ( 1 - {λ}_{j} ) {M}_{gj}}{{D}_{b}} {r}_{i} ] cos {ψ}_{j} ;$$
and
the speed and the position of the particle are updated by:
$${v}_{id} ( k + 1 ) = w \cdot {v}_{id} ( k ) + {c}_{1} \cdot {r}_{1} \cdot [ {pbest}_{id} ( k ) - {x}_{id} ( k ) ] + {c}_{2} \cdot {r}_{2} \cdot [ {gbest}_{id} ( k ) - {x}_{id} ( k ) ]$$
$${x}_{id} ( k + 1 ) = {x}_{id} ( k ) + {v}_{id} ( k + 1 )$$
wherein, i=1, 2, . . . , m is an updated algebra; d=1, 2, . . . , D is a dimension of a search space, D being a number of unknowns in a fitness equation; v_{id}(k) and v_{id}(k+1) are a present speed and an updated speed of ith and (i+1)th generations of particle swarms, x_{id}(k) and x_{id}(k+1) are a present position and an updated position of the ith and (i+1)th generations of particle swarms, pbest_{id}(k) is a personal best value searched for the particle, gbest_{id}(k) is a global best value searched for the population, w is an inertia weight, represents an influence of the particle on a present speed, and has a capability of balancing global convergence and local convergence, c₁ and c₂ each are an acceleration constant, and represent an acceleration weight of a position for pushing the particle to the personal best value and the global best value; and r₁ and r₂ each are a random number within [0, 1];
step 4: updating a personal best value and a global best value of the dual population, comparing each of the particles in the population s1 and the population s2 with a present personal best value according to the fitness value, and selecting an optimal personal best value pbest_{id}(k) and a global best value gbest_{id}(k) having a minimum fitness value;
step 5: employing a dynamic cooperation strategy of the dual population, establishing a cooperative relationship through a neighborhood model, and sharing a personal best value and a global best value searched by each of the populations in the dual population;
step 6: determining an algorithm termination condition, terminating, if a present number of iterations is up to the maximum number of iterations, circulation and considering that optimization on the contact angle between the ball and the inner ring in the ball bearing is accomplished, or otherwise, going back to step 3 for continuous iterative operation; and
step 7: obtaining the contact angle between the ball and the outer ring through an optimized contact angle between the ball and the inner ring in step 6 and according to a mathematic relationship between the contact angle of the inner ring and the contact angle of the outer ring, thereby completing simulation on the dynamic contact characteristics of the high-speed heavy-load ball bearing.

9. The simulation method for dynamic contact characteristics of a high-speed heavy-load ball bearing in a liquid rocket engine according to claim 1, wherein when the iterative computation is performed on the low-speed heavy-load ball bearing model of the liquid rocket engine, a Newton-Raphson iterative method is used.

10. The simulation method for dynamic contact characteristics of a high-speed heavy-load ball bearing in a liquid rocket engine according to claim 1, wherein the ball bearing has a DN value of ≥2.5×10⁶ mm·r/min, and a ratio of a dynamic equivalent radial load Pr of the ball bearing to a dynamic load rating Cr of the ball bearing is >0.15.
